(19) United States
(12) Patent Application Publication
(10) Pub. No.: US 2007/0192116 A1
(43) Pub. Date: Aug. 16, 2007

(54) Position-sensitive events

(75) Inventor: John H. Lovitt, Spring Hill, KS (US)

Correspondence Address: David L. Terrell;GARMIN INTERNATIONAL, INC., 1200 East 151st Street, Olathe, KS, 66062, US

(73) Assignee: GARMIN LTD., a Cayman Islands corporation

(21) Appl. No.: 11/351,600

(22) Filed: Feb. 10, 2006

(51) Int. Cl. G06Q 99/00

(52) U.S. Cl. 705/1

(57) ABSTRACT

Techniques for position-sensitive events are provided. Positioning information is used to acquire events for a given geographical location or within a configurable distance of that geographical location. In an embodiment, a route is provided from a current position of a requester to a destination location associated with a selected one of the events.

### FIELD

The invention relates generally to search and retrieval and more particularly to techniques for storage and retrieval of position-sensitive events.

### BACKGROUND

Typically, a community, government, or enterprise has a public relations campaign or a chamber of commerce that will advertise or will attempt to communicate events that are scheduled for the community. In some cases, the events are published regularly via event calendars within newspapers, magazines, or websites. Visitors to or locals within the community, may view the event calendars and perhaps make decisions to frequent the venues or the events listed therein.

One problem with printed communication is that the visitors or the locals have to have easy access to event publications at convenient locations throughout the community in order to ensure that the interested people are seeing the community information. Of course, this assumes that people will know to look for the publication or will visit a proper location where the publication is placed.

Still another problem, which is associated with online communication, is that often a visitor will frequent a publishing website before his/her travel commences to a community, and then once he/she is in the community access to the Internet may be restricted or may not be available at all. Consequently, unless a visitor remembers to print out an events calendar or write down specific events of interest, then there is little chance the website will be of any value to him/her. Also, any online events calendar must be optimally indexed and available over the Internet to ensure that even interested parties can properly locate it when desired via a search and retrieval engine.

In addition to distributing event calendar information, another problem exists with the value of the content included within the event publications. That is, often the descriptions of the events include a date, a time, a general description, and an address to a location or a venue name for the event. However, visitors may not know the location of a specific venue name and may not know how to get to a specific address. Consequently, some event calendars may publish a small map, which is usually not drawn to scale, having popular streets and interstates labeled in an attempt to generally aid the visitor to a specific location.

In some cases, a contact number may also be listed, which identifies where the visitor can call and get more detailed directions. Although as more and more enterprises and governments cut back on staff, such contact phone numbers are becoming less and less common and are often very difficult to find within a printed publication or within an online publication. The lack of specific directions to a venue or to an address makes it less likely that an undecided visitor will venture out in new surroundings for purposes of frequenting a specific event.

Communication of events is not restricted to visitors; events may also be related to jobs desired by an applicant within a given community, houses or land for sale within the community, and/or volunteer opportunities within the community. The distribution and use of these other types of events experience similar problems as event calendars for communities, namely how to effectively distribute the information and how to make the information convenient and most valuable to a particular consumer.

Thus, even with the advent of the information age and the Internet, communities, governments, and businesses still face challenges in distributing valuable event information to consumers and distributing that event information in a format that is easily comprehended so as to make it more likely that a particular consumer will frequent a particular event.

### SUMMARY

In various embodiments, techniques for processing position-sensitive events are presented. More specifically, and in an embodiment, a method representing a position-sensitive event service is provided. Positioning information is received from a requester and a repository is queried for events within a configurable geographic distance of a location that is associated with the positioning information. Finally, the events are presented to the requestor.

### BRIEF DESCRIPTION OF THE DRAWINGS

FIG. 1 is a diagram of a method representing a position-sensitive event service, according to an example embodiment.

FIG. 2 is a diagram of a method representing an event requesting service, according to an example embodiment.

FIG. 3 is a diagram of a position-sensitive event system, according to an example embodiment.

FIG. 4 is a diagram of another position-sensitive event system, according to an example embodiment.

### DETAILED DESCRIPTION

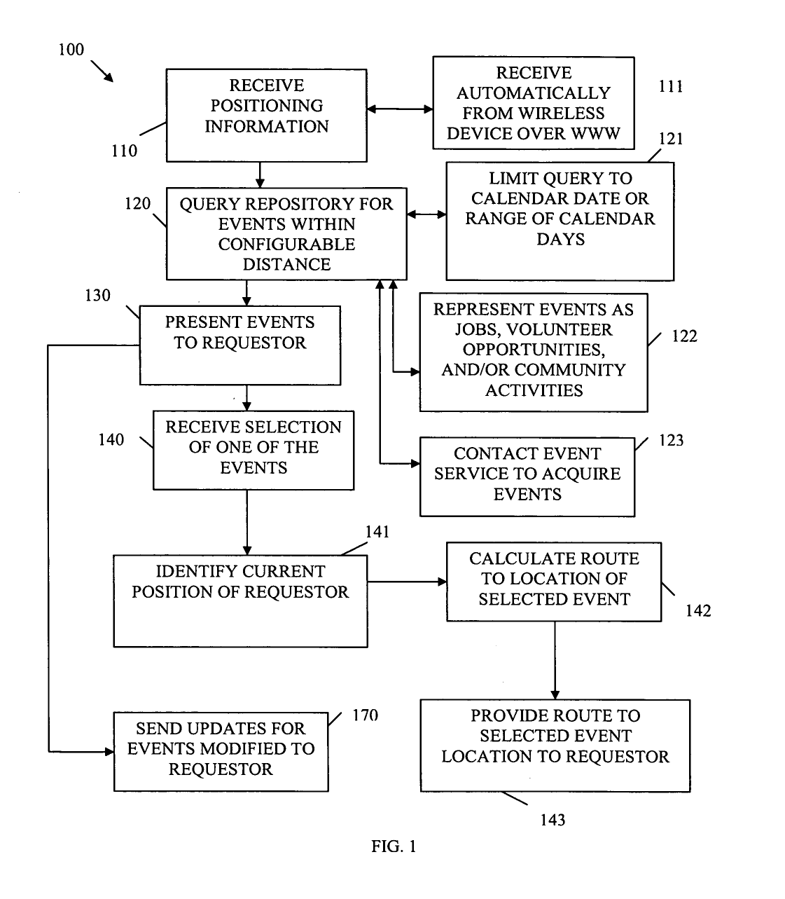

FIG. 1 is a diagram of a method 100 representing a position-sensitive event service, according to an example embodiment. The method 100 (hereinafter referred to as the “position-sensitive event service”) is implemented in a machine-accessible and readable medium and is accessible over a network. The network may be wired, wireless, or a combination of wired and wireless.

The position-sensitive event service is implemented as a network service and may be contacted and interfaced with by a variety of network-enabled devices, such as but not limited to, a personal digital assistant (PDA), a laptop personal computer (PC), a tablet PC, a phone, a GPS-enabled device, and the like. In an embodiment, the position-sensitive event service is implemented as a web portal over the Internet and accessible via the World-Wide Web via browsers.

The position-sensitive event service is implemented to cull events for a given geographic location and present the events to a requestor. In some cases, as will be described in greater detail herein and below, the position-sensitive event service may also be used to generate a route from a current position of a requesting device to a location associated with a given event.

As used herein an “event” may refer to a community or business activity, a job posting, a home listing, a classified advertisement, a volunteer need or opportunity, and the like. For example, in an embodiment, a volunteer or, non profit organization may post needs for goods and services as events for a given geographic location. In other examples, an event may represent any classified advertisement or sporting, government, or community scheduled event.

At 110, the position-sensitive event service receives positioning information from a requester. The position information may be received as a longitude and latitude coordinate, an address, a landmark descriptor (e.g., Yankee Stadium, White House, Gold Gate Bridge, etc.), and the like. In an embodiment, at 111, the positioning information may be received over a wireless network from a portable device over the WWW, such as from a phone, a GPS-enabled device, a laptop, a PDA, and others.

It should be noted that the positioning information may also be received over a wired network from a personal computer, such as a computer being connected to the Internet and having access to the WWW via a browser, where the positioning information is supplied by selecting a location from a list or by manually inputting the positioning information into a form or entry field of a WWW page.

At 120, the position-sensitive event service queries a repository for events within a configurable distance of the received positioning information. The repository may be managed by the position-sensitive event service or may be identified via lists or tables, such that the repository may be logically searched and assembled from the lists or tables. Therefore, the repository may include a single data store or a variety of logically assembled data stores. A data store may be a directory, a database, a WWW information portal service, an electronic file, a data warehouse, or various combinations of the same.

In an embodiment, at 121, the position-sensitive event service may use a variety of other constraints to restrict the query of the repository for the events associated with the positioning information. For example, the query may be limited or restricted to a specific calendar date, a range of calendar days, and the like.

As was previously noted and in an embodiment, at 122, the events themselves may be represented as jobs, volunteer opportunities, and/or community or enterprise activities. In a sense, anything that may be posted on community bulletin boards or in classified advertisements for a community may be considered an event, so long as the event is tied to a specific geographic location.

According to an embodiment, at 123, the actual repositories may be controlled by event publication services. In these embodiments, the position-sensitive event service may interact automatically with the event publication services to process the query for the events for a given geographic location that is represented by the positioning information.

At 130, the position-sensitive event service presents the events to the requestor that are returned as a search answer set associated with the search request. The presentation may be achieved via a variety of techniques. For example, a dynamically created WWW page may be created along with hypertext links to specific events and event descriptions. As another example, the answer set may be downloaded to a portable device associated with the requestor and accessed offline from any network connect as desired by the requestor.

In an embodiment, a requester may make a selection of one of the events associated with the returned answer set. Accordingly, at 140, a selection for one of the events is received by the position-sensitive event service. The selection is associated with a requested operation to generate or produce a navigation route from a current position associated with a portable device of the requestor to a destination location associated with a geographic location of the selected event.

With this latter embodiment, at 141, a current position of the portable device of the requestor is identified. This can be achieved when the position is dynamically acquired via a GPS-enabled device or manually supplied by the requestor via an interface, such as a WWW browser form. Once the current position of the portable device of the requestor is known, at 142, a route is calculated using cartographic data to navigate the requestor from the current position to a destination position or location, where the destination represents a geographic location of the selected and desired event selected by the requestor.

In an embodiment, the calculated route is processed by the position-sensitive event service remote from the device of the requestor. However, it is noted that in some cases, the position-sensitive event service may actually supply the destination position or location for the selected event to the portable device of the requestor and the requestor's device uses route generating services or software to calculate the route.

Once the route is known, at 143, the route is provided to the requestor. The route represents a navigation path from a current position of the requester or a portable device of the requestor to a desired destination location associated with a selected event.

The current position of the requestor or the requestor's device is relative. This means that the requestor may want to manually define a current position knowing that at particular point in time when the route is desired the requestor will be at such a position. For example, assume that a requestor is flying into a location and wants directions from the airport to a baseball stadium. In such a case, the route may be requested in advance by selecting a baseball game from a returned event search for a city being visited by the requestor and by providing a current position as the airport of that city. In this sense, the current position is relative and modifiable by the requester.

In other embodiments, the process of acquiring the route is more dynamic and automatic. For example, consider a requester having a GPS-enabled device that dynamically selects a baseball game at a particular airport within a city from a list of available events within a given geographical distance. In such a scenario, the device may dynamically communicate its current position to the position-sensitive event service or the position-sensitive event service may dynamically communicate the position of the baseball stadium. A route from the current position to the baseball stadium is then dynamically calculated either by the device or by the position-sensitive event service on behalf of the device.

According to an embodiment, at 170, the position-sensitive event service may be designed to detect when events that were requested or selected by a requestor are modified. In such cases, dynamic and real time updates may be pushed to the requestors to notify them of the changes.

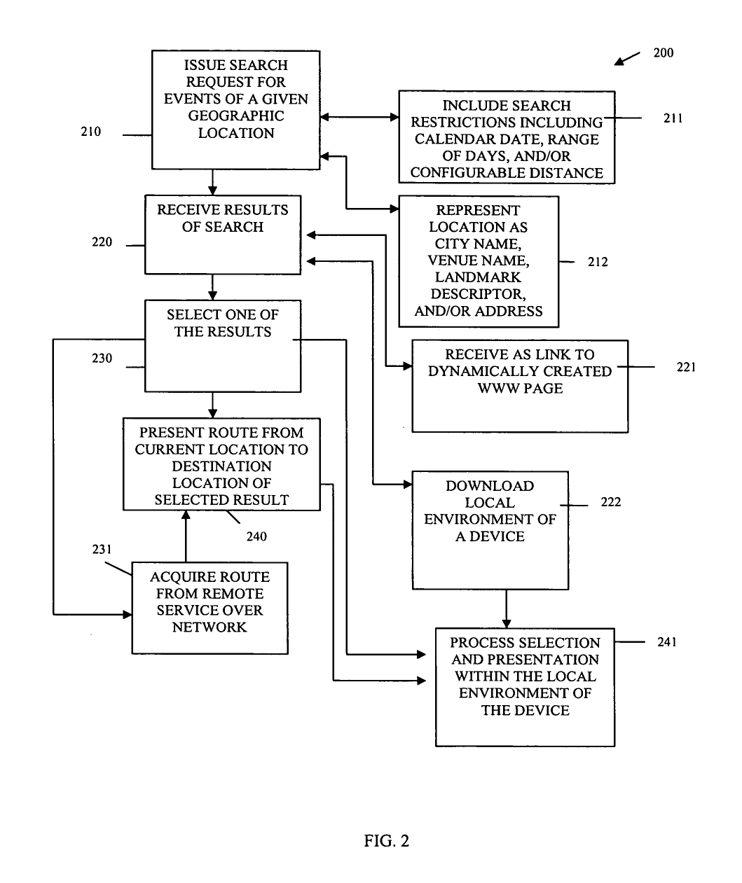

FIG. 2 is a diagram of a method 200 representing an event requesting service, according to an example embodiment. The method 200 (hereinafter referred to as the “event requesting service”) is implemented in a machine-accessible and readable medium and is accessible over a network. The network may be wired, wireless, or a combination of wired and wireless.

The event requesting service is implemented on a device that interfaces over a network with the method 100 of FIG. 1 for purposes of acquiring events for a given geographic location. The event requesting service may be implemented within wireless portable devices, such as PDA's, tablet PC's, phones, laptops, and the like. Additionally, the event requesting service may be implemented on a PC or standalone processing device as a software service that interacts with a position-sensitive event service over a network, which is wired, wireless, or a combination of wired and wireless.

At 210, the event requesting service, which is interacting with a requestor via interfaces, issues a search request for events from a given geographical location. The given geographical location may be selected from a list or may be provided by a requestor manually as an alias, a label, a city name, an address, a landmark description, and/or a longitude and latitude coordinate point.

In an embodiment, at 211, the search may include a variety of search restrictions. The restrictions may be supplied by the requestor or may be associated with profiles of the requestor or configurations of the event requesting service. Some example restrictions may include a calendar date, a range of calendar days, and/or a configurable geographical distance within which the events search is to take place. For example, a search may state search for volunteer opportunities in New Orleans, La. for the week of Sep. 5, 2005 within a 50 mile radius of the city. In fact, some limitations may also include an event type, such as volunteer opportunities, job opportunities, sporting events, cultural events, etc. Again, the geographic location may be represented, at 212, in a variety of manners, such as a city name, a venue name, a landmark description, and/or an address.

At 220, results of the search request are received from a position-sensitive event service, such as the position-sensitive event service represented by the method 100 of FIG. 1. The search results may be received in a variety of manners.

For example, at 221, the search results may be received as a link or universal resource locator (URL) to a dynamically created WWw page. The position-sensitive event service generates and formulates the WWW page and creates an URL for it, the URL is then communicated back to the event requesting service as a result of the initial issued search request.

In another example, at 222, the results are downloaded to a local environment of the device that processes the event requesting service. In this embodiment, the events associated with the search may be viewed offline by a requestor at the leisure of the requester, since the events are downloaded within the device of the requester and are available whenever the device is powered up.

At 230, a selection is made or received by the event requesting service for a particular one of the events in the results. A selection may be made by a requester double-clicking or otherwise identifying a particular one of the events from the results. The selected event is associated with a particular geographic location, such that a route may be generated from a device-specific geographic location or from a requestor provided location to the event location.

In an embodiment, at 231, the route may be acquired from a remote service over the network. The remote service may be a position-sensitive event service, such as the position-sensitive event service represented by the method 100 of FIG. 1. According to an alternative embodiment, the route may be processed by a route guidance service within a device that also processes the event requesting service. Thus, route calculation can occur remotely over a network or locally within a same device that processes the event requesting service.

Three pieces of information or data are used to generate the route, a current location, a destination location, and cartographic data having map information. Other factors may be used as well, such as most use of interstates, shortest time, shortest distance, and the like. The current location may be automatically acquired from a device or it may be manually supplied or identified by the requestor. Examples of acquiring the current location were provided above with the description of the position-sensitive event service represented by the method 100 of FIG. 1.

Accordingly, at 240, the event requesting service presents a route from a current location to a destination location of the selected result. The presentation may be textual, graphical, or a combination of textual and graphical. Moreover, the presentation is available within a device associated with the event requesting service. In an embodiment, the presentation may also include audible route guidance and dynamic tracking of the current location as it moves through the route to the destination location.

In an embodiment, at 241, the process of selecting an event from the search results, calculating a route from a current location to the selected event location, and presenting the route may all be performed within the local environment of a device that processes the event requesting service. That is, a network connection to a position-sensitive event service is not required after the events associated with the search results are downloaded, at 222, from the position-sensitive event service. In such an embodiment, the event requesting service has all the information and processing it needs to select a desired event, calculate a route to the event location, and present the route to a requestor interfacing to the device. This assumes that the search results for the events include event locations and that cartographic data is available to the device for purposes of deriving the route.

It is now understood how two services may interact with one another to provide novel position-sensitive events to requestors or consumers. One service processes remotely over a network and is identified as a position-sensitive event service. The other service processes on a local device of a requestor and is identified as an event requesting service. The event requesting service provides positioning information and perhaps other search constraints to the position-sensitive event service. The position-sensitive event service accesses one or more event repositories and acquires events within the parameters of the positioning information and any other search limitations. Next, a route is generated for a selected event associated with the search results and presented to the requestor. The route may be remotely generated by the position-sensitive event service or may be locally generated by the event requesting service.

These cooperating services provide consumers with geographically sensitive events and directions to navigate to desired event locations. This type of automated processing is not conventionally available in a centralized and one-stop processing manner. Accordingly, the techniques presented are more convenient for a consumer and thus more likely to be used and to provide benefit to a community or an enterprise associated with the events.

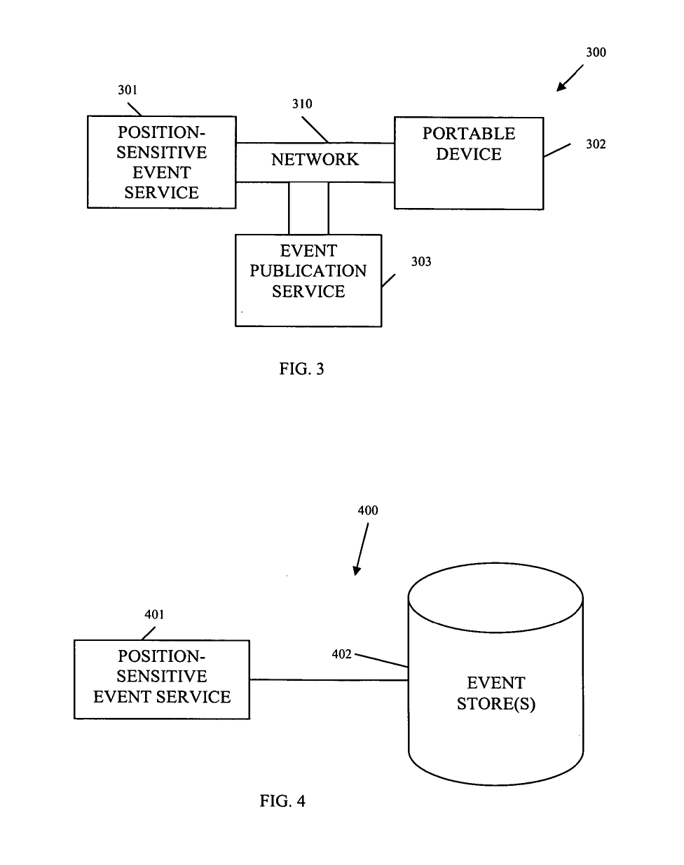

FIG. 3 is a diagram of a position-sensitive event system 300, according to an example embodiment. The position-sensitive event system 300 is implemented in a machine-access and readable medium and is enabled to communicate over a network.

The position-sensitive event system 300 includes a position-sensitive event service 301 and a portable device 302. In an embodiment, the position-sensitive event system 300 may also include one or more event publication services 303. The components of the position-sensitive event system 300 communicate with one another over a network 310. The network 310 may be wired, wireless, or a combination of wired and wireless. Each of the components will now be discussed in turn.

The position-sensitive event service 301 is responsible for acquiring events for a given geographical location or given positioning information. Positioning information may include data that is derived into a specific geographical location, such as an alias for a location, a landmark descriptor, an address, and the like. The position-sensitive event service 301 may process specific geographical locations or positioning information, which the position-sensitive event service 301 resolves to appropriate geographical locations.

The position-sensitive event service 301 receives the positioning information or the geographical locations over the network 310 from a portable device 302. The portable device 302 includes an event requesting service, such as the event requesting service represented by the method 200 of FIG. 2. A requestor interacts with interfaces of the portable device 302 to communicate over the network with the position-sensitive event service 301.

The portable device 302 may include a PDA, a tablet PC, a GPS-enabled device, a phone, a laptop, and the like. In an embodiment, the interfaces of the portable device are WWW enabled using Internet and browser-based communications.

The service and interfaces processing on the portable device 302 communicate with the position-sensitive event service 301 over the network 301 to communicate the positioning information or geographical location and perhaps other search constraints. Some other search constraints may include such things as a specific calendar date, a range of calendar dates, a range for a geographical distance within which the search for events should be performed, and the like.

In response to a formed search, the position-sensitive event service 301 searches one or more event repositories for the given positioning information or geographical location and any other search constraints. The result is a list of events. An event may be a community activity, sporting event, cultural event, job applications, volunteer opportunities, classified advertisement, and the like. The event is considered position sensitive, since the event is related to the positioning information or geographical location and is not relevant outside that context. In some cases, the search constraints may also be restricted to specific classifications for events, such as sporting events, cultural events, volunteer opportunities, and the like.

In an embodiment, the position-sensitive event system 300 may also include one or more event publication services 303. The event publication service 303 permits events to be registered for given geographical locations and indexed in one or more repositories. The event publication service 303 also interacts with the position-sensitive event service 301 for purposes of conducting the searches formulated by requesters using services of the portable device 302. Thus, the event publication service 303 may permit the centralized management of event-sensitive information and provide a mechanism for the position-sensitive event service 301 to utilize in acquiring search results for events.

In some embodiments, a requestor may use services and/or interfaces of the portable device 302 to locally view the search results of the position-sensitive event service 301 or to remotely view the search results. That is, the search results may be downloaded over the network 310 to the portable device or may be accessed dynamically on demand from a remote environment associated with the position-sensitive event service 301.

According to an embodiment, the services or interfaces of the portable device 302 are directed by a requestor to select a specific event from search results. This selection indicates a desire on the part of the requestor to acquire a route to an event location associated with the selected event. To acquire the route, a current or starting location is provided either automatically from services associated with the portable device 302 or from manual entry or selection provided by the requestor. So, the starting location may represent an actual and current geographical location of the portable device 302 or it may represent a desired starting, current, or geographical location identified by the requestor.

The route may be calculated by either the position-sensitive event service 301 or by a service processing on the portable device 302. Once the route is known, it is supplied to the requestor via interfaces and route guidance services processing on the portable device 302. Route guidance may be provided graphically, audibly, textually, or by various combinations of the same.

FIG. 4 is a diagram of another position-sensitive event system 400, according to an example embodiment. The position-sensitive event system 400 is implemented in a machine-accessible and readable medium and is accessible over a network. The network may be wired, wireless, or a combination of wired and wireless. The position-sensitive event system 400 of FIG. 4 presents an alternative view of the position-sensitive event system 300 presented in FIG. 3.

The position-sensitive event system 400 includes a position-sensitive event service 401 and one or more event stores 402. Each of these will now be discussed in turn.

The position-sensitive service 401 is adapted to query and update the one or more event stores 402 for events in response to positioning information. The position-sensitive service 401 may store events with positioning information within the one or more event stores 402 or may query and retrieve events from the one or more event stores 402 in response to positioning information. Examples of position-sensitive services 401 were provided above with respect to the method 100 of FIG. 1 and the position-sensitive service 301 of the position-sensitive service 301 of FIG. 3.

In an embodiment, the position-sensitive service 401 generates one or more routes from current positions communicated by requestors to event locations associated with events that are returned in response to event searches for specific geographical locations.

According to an embodiment, the position-sensitive service 401 interacts with requestors over the Internet via WWW browser pages. In some cases, the position-sensitive service 401 dynamically generates and populates WWW pages to present the events from searches to the requesters.

The one or more event stores 402 represent a logical event repository that is indexed and accessible based on specific geographical locations. The specific geographical locations may be derived from positioning information supplied by requesters.

In an embodiment, the one or more event stores 402 may be accessible to event services that are also in communication with the position-sensitive event service 401. The event services may store and manage the events that are geographically sensitive. The event services may directly interact with and manage the events of the one or more event stores 402 and interface with the position-sensitive event service 401 to perform searches against the event stores 402 and to return event results associated with searches.

One now appreciates how events may be organized, stored, and retrieved in a geographically sensitive manner so as to provide more timely, integrated, and useful information to consumers for particular geographic locations. Such techniques and organization were not available in the past and were not integrated in an easily consumed format.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
receiving positioning information from a requestor;
querying a repository for events within a configurable geographic distance of a location associated with the positioning information; and
presenting the events to the requestor.

2. The method of claim 1, wherein querying further includes limiting the query to at least one of a calendar date or a range of calendar days.

3. The method of claim 1, wherein querying further includes representing the events as at least one of job opportunities, volunteer opportunities, and community activities.

4. The method of claim 1, wherein receiving further includes receiving the positioning information as at least one of an automatic communication from a wireless device and a user-provided communication from a Word-Wide Web (WWW) browser.

5. The method of claim 1 further comprising:
receiving a selection of one of the events;
identifying a current position of the requestor;
calculating a route from the current position to a location associated with the selection; and
providing the route to the requester.

6. The method of claim 1 further comprising, contacting an event service to acquire the events, wherein an identity of the event service is resolved in response to the positioning information and the configurable geographic distance.

7. The method of claim 1 further comprising, sending updates for one or more of the events to the requestor if modifications are detected.

8. A method, comprising:
issuing a search request for events of a given geographic location;
receiving results associated with the search request;
selecting one of the results; and
presenting a route from a current location to a destination location associated with the selected result.

9. The method of claim 8, wherein issuing further includes submitting with the search request a calendar date or range of calendar days that restricts a search to the calendar day or the range of calendar days and restricts the search to a configurable distance within the given geographic location.

10. The method of claim 8, wherein issuing further includes representing the given geographic location as at least one of a city name, a venue name, a landmark descriptor, and an address.

11. The method of claim 8, wherein receiving the results further includes receiving the results as a link to a dynamically created World-Wide Web (WWW) page that includes the results.

12. The method of claim 8, wherein receiving further includes downloading the results to a local environment of a device that processes the method.

13. The method of claim 12, wherein the selecting and the presenting are performed within the local environment of the device.

14. The method of claim 8 further comprising, acquiring the route from a remote service over a network in response to the current location and the destination location.

15. A system, comprising:
a position-sensitive event service; and
a portable device, wherein the portable device is to communicate over a network with the position-sensitive event service and is to communicate positioning information to the position-sensitive event service, and wherein the position-sensitive event service is to communicate events associated with the positioning information to the portable device.

16. The system of claim 15, wherein the portable device is at least one of a phone, a laptop, a personal computer (PC), a personal digital assistant (PDA), a tablet PC, and a global positioning satellite (GPS) enabled device.

17. The system of claim 15 further comprising, an event service, wherein the event service is to communicate the events to the position-sensitive event service in response to search parameters.

18. The system of claim 17, wherein the search parameters include at least one of the positioning information, a configurable distance within the positioning information, a calendar date, a range of calendar days, and a category associated with a specific type of event.

19. The system of claim 15, wherein the position-sensitive event service and the portable device communicate with one another over at least one of a wireless network, a wired network, and a combination of wired and wireless networks.

20. A system, comprising:
a position-sensitive event service; and
one or more event stores, wherein the position-sensitive event service is to query and update the one or more event stores for events in response to positioning information, and wherein the position-sensitive event service is to present the events to requestors.

21. The system of claim 20, wherein position-sensitive event service is to generate routes from current positions of the requesters to locations associated with selected ones of the events.

22. The system of claim 20, wherein the one or more event stores are to be accessed through one or more event services in communication with the position-sensitive event service.

23. The system of claim 20, wherein the position-sensitive event service is to interact with the requestors over the Internet.

24. The system of claim 23, wherein the position-sensitive event service is to dynamically generate World-Wide Web (WWW) pages for presenting the events to the requesters within a browser interface.
